(19) United States
(12) Patent Application Publication
(10) Pub. No.: US 2005/0111516 A1
(43) Pub. Date: May 26, 2005

(54) Optical pickup apparatus

(76) Inventors: Takuji Hatano, Suita-shi (JP); Yuichiro Ori, Moriyama-shi (JP); Katsuya Yagi, Hino-shi (JP); Yuichi Atarashi, Hachioji-shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/982,053

(22) Filed: Nov. 4, 2004

(30) Foreign Application Priority Data
Nov. 10, 2003 (JP) 2003-379573

(51) Int. Cl. H01S 3/08

(52) U.S. Cl. 372/106; 369/112.16

(57) ABSTRACT

An optical pickup apparatus detects optical information by making a laser beam in a 405 nm wavelength band emitted from a semiconductor laser light source incident on an optical information recording medium and then making the laser beam reflected from the optical information recording medium incident on a photodetector. The optical pickup apparatus has a polarizing beam splitter including a polarizing beam splitting film that forms an optical path from the semiconductor laser light source to the optical information recording medium by reflecting the s-polarized component of the laser beam and that forms an optical path from the optical information recording medium to the photodetector by transmitting the p-polarized component of the laser beam; and a monitoring sensor that receives the laser beam to monitor the laser output intensity of the semiconductor laser light source. The polarizing beam splitter transmits part of the s-polarized component, and the monitoring sensor receives this part of the s-polarized component in a position where the center line of the effective light beam received by the monitoring sensor does not coincide with the principal ray of that part of the s-polarized component.

This application is based on Japanese Patent Application No. 2003-379573 filed on November 10, 2003, the contents of which are hereby incorporated by reference.

### BACKGROUND OF THE INVENTION

1. Field of the Invention

The present invention relates to an optical pickup apparatus, and more particularly to an optical pickup apparatus that can record and reproduce optical information to and from a high-density optical information recording medium by the use of at least a blue-violet laser beam.

2. Description of Related Art

In recent years, high-density optical information recording media (hereinafter referred to as “high-density media”) adapted to a blue-violet laser beam around a wavelength of 405 nm and optical disk apparatuses for recording and reproducing information to and from them have been developed eagerly. Recording and reproducing information to and from such high-density media require very accurate optical pickup apparatuses. To enhance the accuracy of an optical pickup apparatus, it is necessary to control very accurately the amount of light contained in a laser beam in a 405 nm wavelength band (specifically, with a wavelength of 405±10 nm). Common semiconductor laser light sources, even when equal currents are passed through them, output laser beams containing varying amounts of light according to temperature and variations in their characteristics from one individual to another. To cancel such variations, it is customary to adopt automatic power control (APC). Automatic power control uses a monitoring sensor that receives a laser beam to monitor the laser output of a semiconductor laser light source, and, based on the result of the monitoring, the laser output is so controlled that the amount of light contained in the laser beam is kept constant.

Ideally, the output of the monitoring sensor used in APC should be proportional to the laser output and not depend on wavelength. In reality, however, the sensitivity of a photodetector used as the monitoring sensor is highly dependent on wavelength, and its sensitivity decreases with decreasing wavelength, with the peak in a 780 nm wavelength band. Thus, a variation in wavelength resulting from a variation in temperature, in the laser output level, or in any other relevant factor makes it impossible to obtain the sensor output needed for APC. To cope with this wavelength dependence of the photodetective sensitivity, Patent Publication 1 listed below proposes a sensor provided with capabilities for wavelength conversion and wavelength selection.

### Patent Publication 1: Japanese Patent Application Laid-Open No. H8-227533

However, the sensor disclosed in Patent Publication 1 is a photodetective device designed for a signal system that receives a laser beam reflected from an optical disk, and, with this construction, whereas it is indeed possible to alleviate the influence of wavelength variation, it is not possible to cancel the variation of the amount of light contained in the laser beam.

### SUMMARY OF THE INVENTION

In view of the conventionally experienced problems discussed above, it is an object of the present invention to provide an optical pickup apparatus that can cope with high-density media adapted to a blue-violet laser and that can highly accurately control the amount of light contained in a laser beam despite having a simple construction.

To achieve the above object, in one aspect of the present invention, an optical pickup apparatus that detects optical information by making a laser beam in a 405 nm wavelength band emitted from a semiconductor laser light source incident on an optical information recording medium and then making the laser beam reflected from the optical information recording medium incident on a photodetector is provided with: a polarizing beam splitter including a polarizing beam splitting film that forms an optical path from the semiconductor laser light source to the optical information recording medium by reflecting the s-polarized component of the laser beam and that forms an optical path from the optical information recording medium to the photodetector by transmitting the p-polarized component of the laser beam; and a monitoring sensor that receives the laser beam to monitor the laser output intensity of the semiconductor laser light source. Here, the polarizing beam splitter transmits part of the s-polarized component, and the monitoring sensor receives this part of the s-polarized component in a position where the center line of the effective light beam received by the monitoring sensor does not coincide with the principal ray of that part of the s-polarized component.

In another aspect of the present invention, an optical pickup apparatus is provided with: a semiconductor laser light source that emits a laser beam in a 405 nm wavelength band; a beam shaping element that receives the laser beam emitted from the semiconductor laser light source, then shapes the laser beam, received in the form of a divergent light beam having an elliptic light intensity distribution, into a light beam having a substantially circular light intensity distribution, and then outputs the thus shaped laser beam; a polarizing beam splitter that reflects the laser beam shaped by the beam shaping element with a polarizing beam splitting film kept in contact with air and that transmits part of the laser beam; an objective lens that focuses the laser beam reflected from the polarizing beam splitter on an optical information recording medium; and a monitoring sensor that receives the laser beam transmitted through the polarizing beam splitting film to monitor the laser output intensity of the semiconductor laser light source. Here, the center line of the effective light beam received by the monitoring sensor is located in the region traveled by the rays that have been transmitted through the polarizing beam splitting film at larger angles of incidence than the principal ray of the laser beam incident on the polarizing beam splitter.

In another aspect of the present invention, an optical pickup apparatus is provided with: a first semiconductor laser light source that emits a laser beam in a 405 nm wavelength band; a second semiconductor laser light source that emits a laser beam in a 650 nm wavelength band; a beam shaping element that receives the laser beam emitted from the first semiconductor laser light source, then shapes the laser beam, received in the form of a divergent light beam having an elliptic light intensity distribution, into a light beam having a substantially circular light intensity distribution, and then outputs the thus shaped laser beam; an optical path integrator that integrates together the optical path of the laser beam shaped by the beam shaping element and the optical path of the laser beam emitted from the second semiconductor laser light source with a multilayer optical thin film; a polarizing beam splitter that reflects the laser beam having the optical paths thereof integrated together by the optical path integrator with a polarizing beam splitting film kept in contact with air and that transmits part of the laser beam; an objective lens that focuses the laser beam reflected from the polarizing beam splitter on an optical information recording medium; and a monitoring sensor that receives the laser beam transmitted through the polarizing beam splitting film to monitor the laser output intensity of the first and second semiconductor laser light sources. Here, the center line of the effective light beam received by the monitoring sensor is located in the region traveled by the rays that have been transmitted through the polarizing beam splitting film at larger angles of incidence than the principal ray of the laser beam incident on the polarizing beam splitter.

In another aspect of the present invention, an optical pickup apparatus is provided with: a first semiconductor laser light source that emits a laser beam in a 405 nm wavelength band; a second semiconductor laser light source that emits a laser beam in a 650 nm wavelength band; a third semiconductor laser light source that emits a laser beam in a 780 nm wavelength band and that is disposed close to the second semiconductor laser light source; a beam shaping element that receives the laser beam emitted from the first semiconductor laser light source, then shapes the laser beam, received in the form of a divergent light beam having an elliptic light intensity distribution, into a light beam having a substantially circular light intensity distribution, and then outputs the thus shaped laser beam; an optical path integrator that integrates together the optical path of the laser beam shaped by the beam shaping element and the optical paths of the laser beams emitted from the second and third semiconductor laser light sources with a multilayer optical thin film; a polarizing beam splitter that reflects the laser beam having the optical paths integrated together by the optical path integrator with a polarizing beam splitting film kept in contact with air and that transmits part of the laser beam; an objective lens that focuses the laser beam reflected from the polarizing beam splitter on an optical information recording medium; and a monitoring sensor that receives the laser beam transmitted through the polarizing beam splitting film to monitor the laser output intensity of the first, second, and third semiconductor laser light sources. Here, the center line of the effective light beam received by the monitoring sensor is located in the region traveled by the rays that have been transmitted through the polarizing beam splitting film at larger angles of incidence than the principal ray of the laser beam incident on the polarizing beam splitter.

The different features involved in these constructions according to the present invention offer the following advantages. One feature lies in that the monitoring sensor receives the laser beam in a position where the center line of the effective light beam for the monitoring sensor does not coincide with the principal ray of the light beam. This makes it possible to match the spectroscopic sensitivity characteristics of the monitoring sensor with the polarizing beam splitting characteristics of the polarizing beam splitting film in such a way as to alleviate the influence of wavelength variation resulting from a variation in temperature, in the laser output level, or in any other relevant factor. Thus, it is possible to realize an optical pickup apparatus that can cope with high-density media adapted to a blue-violet laser and that can highly accurately control the amount of light contained in a laser beam despite having a simple construction.

Another feature lies in that the center line of the effective light beam for the monitoring sensor is located in the region traveled by the rays that have been transmitted through the polarizing beam splitting film at larger angles of incidence than the principal ray of the laser beam incident on the polarizing beam splitter. This permits the spectroscopic sensitivity characteristics of the monitoring sensor and the polarizing beam splitting characteristics of the polarizing beam splitting film to complement each other in such a way as to alleviate the influence of wavelength variation resulting from a variation in temperature, in the laser output level, or in any other relevant factor. Thus, it is possible to realize an optical pickup apparatus that can cope with high-density media adapted to a blue-violet laser and that can highly accurately control the amount of light contained in a laser beam despite having a simple construction.

Another feature lies in that the laser beam in the 405 nm wavelength band, which is emitted in the form of a divergent light beam with an elliptic light intensity distribution, is shaped with the beam shaping element. This makes it possible to achieve optical path splitting with optimum polarizing beam splitting characteristics that fit the incidence-angle dependence of the polarizing beam splitter. Moreover, the shaped laser beam is reflected from the polarizing beam splitting film that is kept in contact with air. This helps simplify the optical construction needed for optical path splitting, and helps increase flexibility in the optical layout. This makes it easy to make the optical pickup apparatus lightweight, slim, compact, and inexpensive. Thus, it is possible to realize an optical pickup apparatus that can cope with high-density media adapted to a blue-violet laser and that can be made compact and inexpensive easily despite having a simple construction.

Another feature lies in that the optical pickup apparatus can cope with optical information recording media adapted to laser beams in both 405 nm and 650 nm wavelength bands. Another feature lies in that the optical pickup apparatus can cope with optical information recording media adapted to laser beams in 405 nm, 650 nm, and 780 nm wavelength bands. Another feature lies in that it is possible to make the most of the polarizing beam splitting characteristics mentioned above to achieve better optical path splitting. Another feature lies in that it is possible to monitor the laser output intensity by receiving a laser beam containing the amount of light that suits the wavelength thereof.

### BRIEF DESCRIPTION OF THE DRAWINGS

FIG. 1 is an optical construction diagram showing the optical pickup apparatus of a first embodiment of the invention;

FIGS. 2A to 2C are graphs showing, in terms of reflectivity, the polarizing beam splitting characteristics of the polarizing beam splitting film used at angles of incidence of 45±4° in the 405 nm wavelength band;

FIGS. 3A to 3C are graphs showing, in terms of reflectivity, the polarizing beam splitting characteristics of the polarizing beam splitting film used at angles of incidence of 35±4° in the 405 nm wavelength band;

FIGS. 4A to 4C are graphs showing, in terms of transmissivity, the polarizing beam splitting characteristics of the polarizing beam splitting film used at angles of incidence of 60±4° in the 405 nm wavelength band;

FIG. 5 is a graph showing the phase shift resulting from the reflection from the polarizing beam splitting film used at angles of incidence of 60±4° in the 405 nm wavelength band;

FIG. 6 is an optical construction diagram showing the optical pickup apparatus of a second embodiment of the invention;

FIGS. 7A to 7C are graphs showing, in terms of transmissivity, the polarizing beam splitting characteristics of the polarizing beam splitting film used at angles of incidence of 60±4° in the 405 nm, 650 nm, and 780 nm wavelength bands;

FIGS. 8A to 8C are graphs showing the phase shift resulting from the reflection from the polarizing beam splitting film used at angles of incidence of 60±4° in the 405 nm, 650 nm, and 780 nm wavelength bands;

FIGS. 9A to 9C are graphs showing, in terms of reflectivity, the polarizing beam splitting characteristics of the polarizing beam splitting film used at angles of incidence of 45±4° in the 405 nm, 650 nm, and 780 nm wavelength bands;

FIGS. 10A to 10C are graphs showing, in terms of transmissivity, the polarizing beam splitting characteristics of the polarizing beam splitting film used at angles of incidence of 45±4° in the 405 nm, 650 nm, and 780 nm wavelength bands;

FIGS. 11A to 11C are graphs showing the phase shift resulting from the reflection from the polarizing beam splitting film used at angles of incidence of 45±4° in the 405 nm, 650 nm, and 780 nm wavelength bands;

FIG. 12 is an enlarged view of a principal portion of FIG. 1;

FIG. 13 is a graph showing the spectroscopic transmissivity characteristic of the optical filter used in the second embodiment; and

FIG. 14 is a graph showing the spectroscopic sensitivity characteristics of the photodetectors used in the embodiments.

### DETAILED DESCRIPTION OF PREFERRED EMBODIMENTS

Hereinafter, optical pickup apparatuses embodying the present invention will be described with reference to the accompanying drawings. It should be noted that, in the following descriptions, such components as find their counterparts, i.e., components functioning identically or similarly thereto, between different embodiments are identified with common reference symbols, and their explanations will not be repeated unless necessary.

### First Embodiment (Single-Wavelength Type)

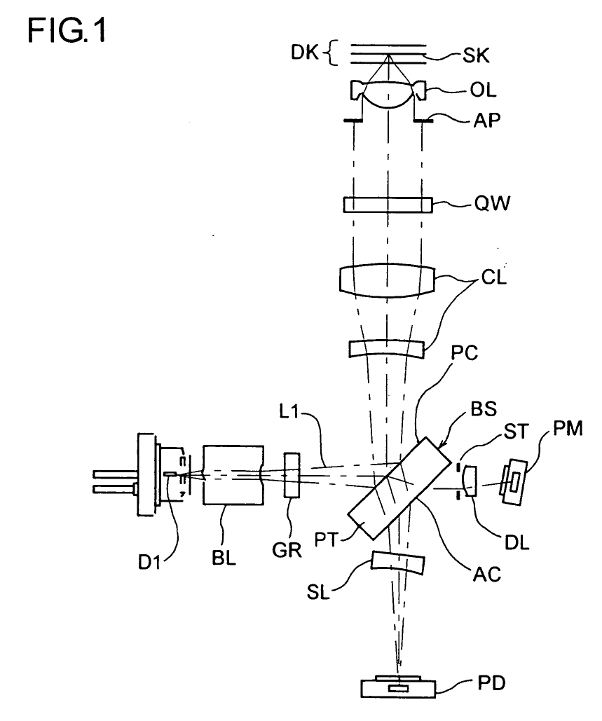

FIG. 1 shows the optical construction of the optical pickup apparatus of a first embodiment of the invention. This optical pickup apparatus is of a single-wavelength type that can record and reproduce optical information to and from a high-density medium (shown as an optical disk DK in the figure) adapted to a blue-violet laser. The optical pickup apparatus includes, as a semiconductor laser light source, a blue laser light source D1 that emits a laser beam L1 in a 405 nm wavelength band (specifically, at a wavelength of 405±10 nm). The laser beam L1 emitted from the blue laser light source D1 is a divergent light beam having an elliptic light intensity distribution, of which the angle of divergence in the direction of the minor axis of the ellipse is equal to the angle of divergence θₚₐᵣ in the direction parallel to the active layer of the diode D1, and of which the angle of divergence in the direction of the major axis of the ellipse is equal to the angle of divergence θₚₑᵣₚ in the direction perpendicular to the active layer of the diode D1 (θₚₐᵣ<θₚₑᵣₚ). Specifically, in this embodiment, θₚₐᵣ=9° and θₚₑᵣₚ=23° (both given in full-angle at half maximum). In the arrangement of the blue laser light source D1 shown in FIG. 1, the angle of divergence θₚₑᵣₚ is parallel to the face of the page, and the angle of divergence θₚₐᵣ is perpendicular to the face of the page. Moreover, the laser beam L1 is linearly polarized in such a way that the electric vector thereof points in the direction parallel to the active layer of the blue laser light source D1.

The laser beam L1 emitted from the blue laser light source D1 in the form of a divergent light beam with an elliptic light intensity distribution is then shaped, by a beam shaping element BL, into a light beam having a light intensity distribution that offers preferable characteristics for the recording and reproduction of optical information. Here, a preferable light intensity distribution is one that gives the light beam, when it is incident on the objective lens OL described later, peripheral intensity ratios (rim intensity) of, for example, 65% in the disk-radial direction and 60% in the disk-tangential direction. The angle of divergence θₚₑᵣₚ of 23° can be allocated to the rim intensity of 65% in the disk-radial direction by directing part of the laser beam L1 corresponding to an NA (numerical aperture) of 0.155 to the aperture stop AP of the objective lens OL; the angle of divergence θₚₐᵣ of 9° can be allocated to the rim intensity of 60% in the disk-tangential direction by directing part of the laser beam L1 corresponding to an NA (numerical aperture) of 0.067 to the aperture stop AP of the objective lens OL. In this embodiment, to obtain the desired rim intensity mentioned above, the beam shaping element BL is given a shaping magnification factor of 0.43× in the direction of the angle of divergence θₚₑᵣₚ and a unity magnification factor in the direction of the angle of divergence θₚₐᵣ.

The laser beam L1 having been shaped by the beam shaping element BL is then incident on a diffraction grating GR, which, for the purpose of tracking by the DPP method or three-beam method, splits the laser beam into a main beam (light of order 0) used to achieve recording and reproduction to and from the optical disk DK and two sub beams (light of orders ±1, omitted in FIG. 1) used to detect tracking errors. The laser beam (main beam) L1 that has exited from the diffraction grating GR is then incident on a polarizing beam splitter BS in the shape of a parallel-plane plate. Here, the laser beam L1 is incident on the polarizing beam splitting film PC at an angle of incidence θ1 of 45° and with a range of angles (angular aperture) α1 of 4°. The polarizing beam splitter BS is composed of a transparent parallel-plane plate PT that serves as a substrate, a polarizing beam splitting film PC that is a multilayer optical thin film (or a multilayer optical thin film coated with a protective film) laid on one side of the parallel-plane plate PT, and an antireflection film AC that is a multilayer optical thin film (or a multilayer optical thin film coated with a protective film) laid on the other side of the parallel-plane plate PT. The polarizing beam splitting film PC has such polarizing beam splitting characteristics as to reflect most of the s-polarized component of the incident light beam and transmit most of the p-polarized component thereof. The laser beam L1 is s-polarized with respect to the polarizing beam splitting film PC. Accordingly, most of the laser beam L1 is reflected from the polarizing beam splitting film PC, which is kept in contact with air. This forms the optical path from the blue laser light source D1 to the optical disk DK.

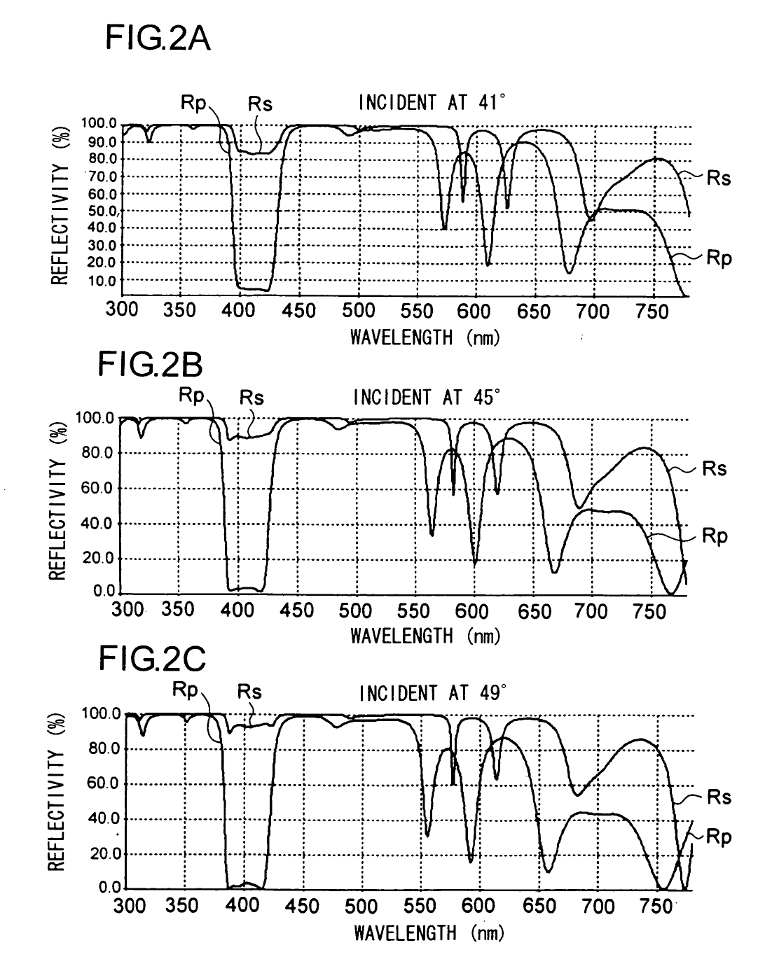

FIGS. 2A to 2C are graphs showing, in terms of reflectivity (%), the polarizing beam splitting characteristics of the polarizing beam splitting film PC used at angles of incidence of 45° (more specifically, 41°, 45°, and 49° in FIGS. 2A, 2B, and 2C, respectively) relative to the film surface in the 405 nm wavelength band, with Rs representing s-polarized light reflectivity and Rp p-polarized light reflectivity. Having such polarizing beam splitting characteristics, this polarizing beam splitting film PC is optimized for use in the first embodiment. Its characteristics are satisfactory in practical terms, offering p-polarized light transmissivity Tp>95% and s-polarized light reflectivity Rs=88±5% in the actual use range of wavelengths from 400 nm to 415 nm in the range of angles of incidence of 45±4°.

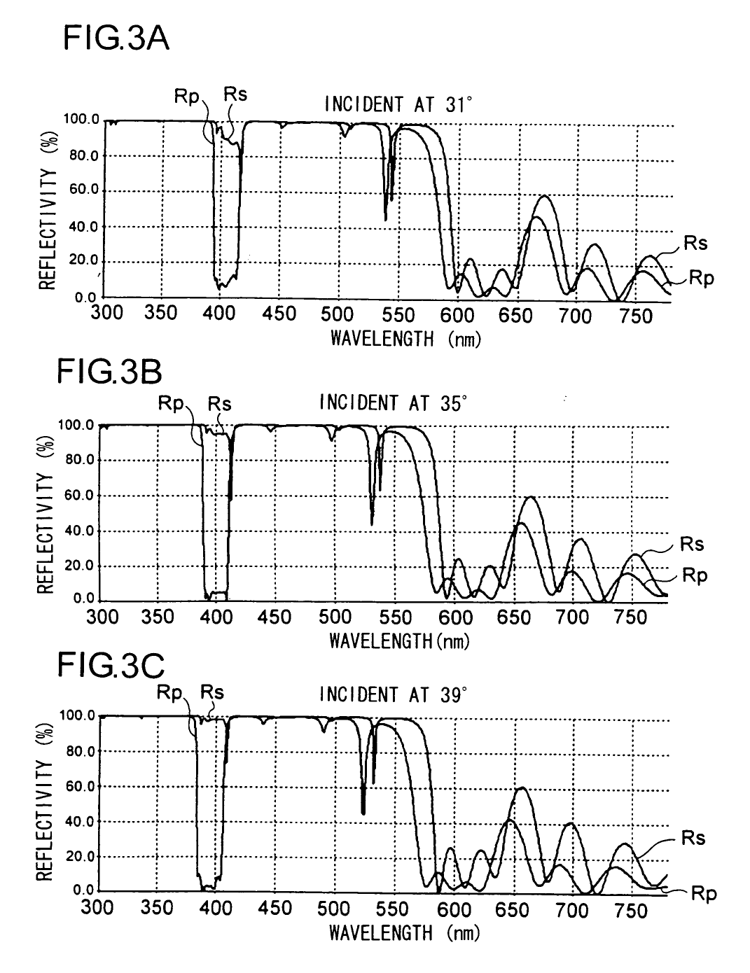

FIGS. 3A to 3C show, in terms of reflectivity (%), the polarizing beam splitting characteristics of the polarizing beam splitting film PC used at angles of incidence of 35±4° (more specifically, 31°, 35°, and 39° in FIGS. 3A, 3B, and 3C, respectively) relative to the film surface in the 405 nm wavelength band, with Rs representing s-polarized light reflectivity and Rp p-polarized light reflectivity. Having such polarizing beam splitting characteristics, this polarizing beam splitting film PC is optimized for a modified arrangement of the polarizing beam splitter BS as compared with its arrangement in the first embodiment. Its characteristics are satisfactory in practical terms, offering p-polarized light transmissivity Tp>90% and s-polarized light reflectivity Rs=94±5% in the actual use range of wavelengths from 400 nm to 415 nm in the range of angles of incidence of 35±4°. By setting the angle of incidence θ1 of the laser beam L1 at 35° in this way, thanks to increased flexibility in the optical arrangement, it is possible to reduce the width of the apparatus as a whole as compared with in a case where θ1 is set at 45°.

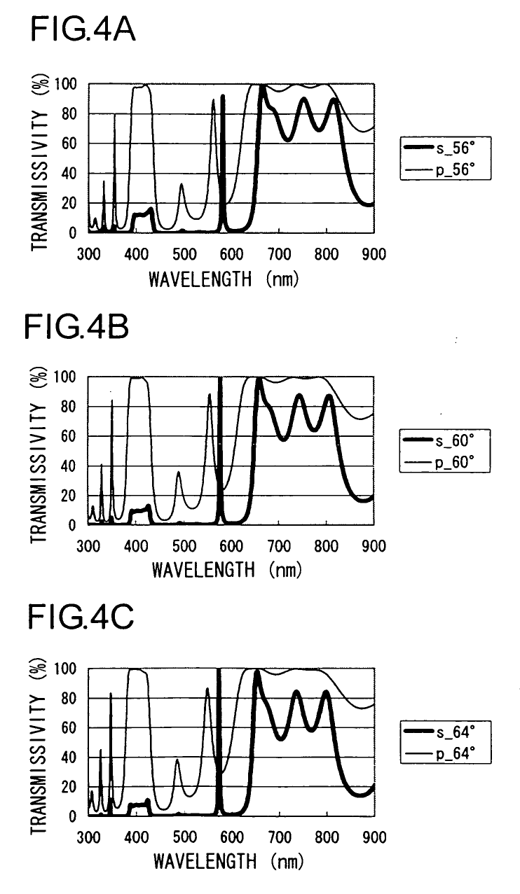

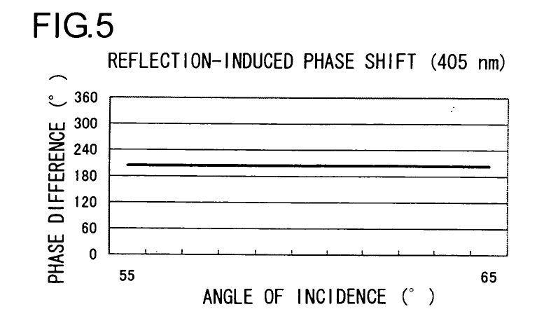

FIGS. 4A to 4C show, in terms of transmissivity (%), the polarizing beam splitting characteristics of the polarizing beam splitting film PC used at angles of incidence of 60±4° (more specifically, 56°, 60°, and 64° in FIGS. 4A, 4B, and 4C, respectively) relative to the film surface in the 405 nm wavelength band, with thick lines representing s-polarized light transmissivity and thin lines p-polarized light transmissivity. Having such polarizing beam splitting characteristics, this polarizing beam splitting film PC is optimized for a modified arrangement of the polarizing beam splitter BS as compared with its arrangement in the first embodiment. Its characteristics are satisfactory in practical terms, offering p-polarized light transmissivity Tp>95% and s-polarized light reflectivity Rs=88±5% in the actual use range of wavelengths from 400 nm to 415 nm in the range of angles of incidence of 60±4°. FIG. 5 shows the reflection-induced phase shift (the phase shift of s-polarized light). As will be understood from FIG. 5, the reflection-induced phase shift is largely linear over the use angle range.

As described earlier, the polarizing beam splitting film PC, which is a multilayer optical thin film, has such polarizing beam splitting characteristics as to reflect most of the s-polarized component of the incident light beam and transmit most of the p-polarized component thereof. To obtain better polarizing beam splitting characteristics, it is generally preferable to reduce the angle of incidence and, where a divergent light beam is involved, to narrow the range of angles of divergence thereof. Accordingly, in a common optical pickup apparatus, a polarizing beam splitting film is typically disposed on a bonding surface inside a glass cube so as to be located in the optical path of a divergent light beam. However, a polarizing beam splitter in the form of a glass cube has a complicated construction involving bonding surfaces, and requires many components; thus, using one leads not only to higher cost but also to less flexibility in the optical layout, resulting in a complicated optical construction. This makes it difficult to make the optical pickup apparatus, and hence the disk apparatus that incorporates it, lightweight, slim, compact, inexpensive, and otherwise improved.

In the construction of this embodiment, the laser beam L1 after shaping is reflected from the polarizing beam splitting film PC, which is kept in contact with air. This helps simplify the optical construction needed for optical path splitting, and helps increase flexibility in the optical layout. This makes it easy to make the optical pickup apparatus lightweight, slim, compact, and inexpensive. Moreover, the use of the polarizing beam splitter BS in the shape of a parallel-plane plate makes it possible to produce astigmatism in the return light that is transmitted therethrough. This makes it possible to achieve focusing and error detection by the astigmatism method. This helps simplify the manufacturing process of the polarizing beam splitter BS, and eliminates the need for an extra element for producing astigmatism, thereby contributing to cost reduction in the optical pickup apparatus. Moreover, since no bonding surfaces are necessary, no absorption of light occurs as would be inevitable through an adhesive layer. This makes it possible to realize an optical system with high light use efficiency. In this way, it is possible to realize an optical pickup apparatus that can cope with high-density media adapted to a blue-violet laser and that can be made compact and inexpensive easily despite having a simple construction.

As described above, to obtain better polarizing beam splitting characteristics, it is preferable to narrow the range of angles of divergence. It is to fulfill the incidence-angle dependence thereof that the beam shaping element BL is used in this embodiment. Specifically, the beam shaping element BL, which reduces the angle of divergence θₚₑᵣₚ, is disposed where the laser beam L1 travels before being incident on the polarizing beam splitter BS. Thus, the beam shaping element BL reduces the angle of divergence of the laser beam L1 in the direction of the ellipse major axis so that the range of angles of incidence thereof relative to the polarizing beam splitting film PC is, although it is incident thereon in air, narrowed to 45±4°. This make it possible to achieve optical path splitting with polarizing beam splitting characteristics that best suit the incidence-angle dependency of the polarizing beam splitter. Moreover, from the viewpoint of film design, narrowing the range of angles of incidence with the beam shaping element BL makes it easy to make the reflection phase of s-polarized light linear.

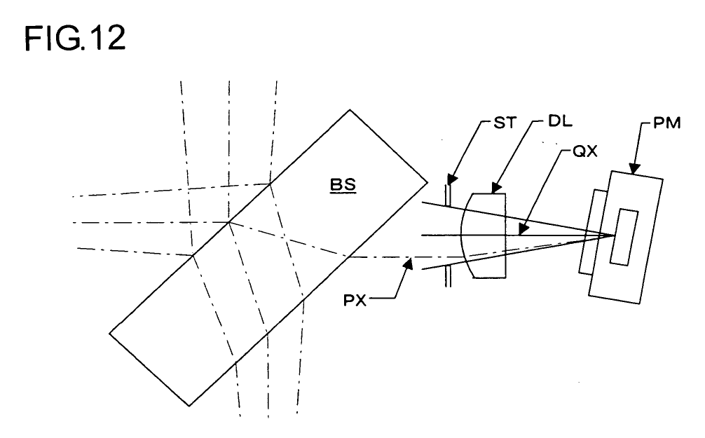

The polarizing beam splitter BS is so designed as to transmit part of the s-polarized component of the laser beam L1 incident thereon. The laser beam L1 that has been transmitted through the polarizing beam splitter BS passes through a stop ST and then through a condenser lens DL, and is then received by a laser power monitor PM. The laser power monitor PM is a monitoring sensor that detects the laser output intensity of the blue laser light source D1 by receiving the laser beam L1 that has been transmitted through the polarizing beam splitter BS. As shown in FIG. 12, this laser power monitor PM is arranged with a slight upward inclination. This arrangement makes the incidence of the principal ray PX relative to the photodetective surface of the laser power monitor PM nonperpendicular, and thus helps avoid stray light and thereby prevent ghosts.

As described earlier, ideally, the output of the laser power monitor PM for APC should be proportional to the laser output and not depend on wavelength. In reality, however, the sensitivity of a photodetector commonly used as the laser power monitor PM is highly dependent on wavelength, and its sensitivity decreases with decreasing wavelength, with the peak in a 780 nm wavelength band. FIG. 14 shows the spectroscopic sensitivity characteristics of two types of photodetector identified as M405 and M655, respectively. Both exhibit high wavelength dependence in the 405 nm wavelength band, and output, even at the same laser power, increasingly high laser output with increasing wavelength. In a common semiconductor laser light source, wavelength variation (±17 nm) is inevitable that results from a variation in temperature, in the laser output level, or in any other relevant factor. Thus, when the laser wavelength shifts to longer wavelengths as a result of a variation in temperature or the like, even if there is no variation in the laser output, the monitor output increases.

On the other hand, in the polarizing beam splitting characteristics (FIGS. 2A-2C to 4A-4C) of the polarizing beam splitting film PC, entrance-angle dependence is recognized in the variation of s-polarized light reflectivity Rs and transmissivity Ts in the 405 nm wavelength band. When attention focused on the s-polarized light that is incident on the laser power monitor PM, for example as will be understood from the spectroscopic reflectivity shown in FIGS. 2A to 2C, as the angle of incidence increases, s-polarized light reflectivity Rs increases (in other words, transmissivity Ts decreases) at longer wavelengths in the 405 nm wavelength band. As described earlier, in a common semiconductor laser light source, wavelength variation (±17 nm) is inevitable that results from a variation in temperature, in the laser output level, or in any other relevant factor. Thus, when the laser wavelength shifts to longer wavelengths as a result of a variation in temperature or the like, the larger the angle of incidence, the more the amount of light incident on the laser power monitor PM decreases.

Accordingly, with the construction in which the laser power monitor PM receives the laser beam L1 in a position where the center line QX of the effective light beam does not coincide with the principal ray PX of the laser beam L1 that has been transmitted through the polarizing beam splitter BS, it is possible to match the spectroscopic sensitivity characteristics of the laser power monitor PM with the polarizing beam splitting characteristics of the polarizing beam splitting film PC. The photodetective range of the laser power monitor PM is effectively restricted by the stop ST.

In this embodiment, the center line QX of the effective light beam for the laser power monitor PM is located in the region traveled by the rays that have been transmitted through the polarizing beam splitting film PC at larger angles of incidence than the principal ray PX of the laser beam L1 incident on the polarizing beam splitter BS. Accordingly, when the laser wavelength shifts to longer wavelengths, the photodetective sensitivity of the laser power monitor PM increases, and the amount of light incident thereon decreases. By contrast, when the laser wavelength shifts to shorter wavelengths, the photodetective sensitivity of the laser power monitor PM decreases, and the amount of light incident thereon increases. In this way, the spectroscopic sensitivity characteristics of the laser power monitor PM and the polarizing beam splitting characteristics of the polarizing beam splitting film PC complement each other so as to alleviate the influence of wavelength variation resulting from a variation in temperature, in the laser output level, or in any other relevant factor. Thus, it is possible to realize an optical pickup apparatus that can cope with high-density media adapted to a blue-violet laser and that can highly accurately control the amount of light contained in the laser beam L1 despite having a simple construction.

The polarizing beam splitter BS receives as p-polarized light the return light from the optical disk DK, and therefore it offers, even without the antireflection film AC, sufficiently high transmissivity Tp. Accordingly, the antireflection film AC may be omitted. However, without the antireflection film AC, an unnegligible reflection loss occurs in the s-polarized light used by the laser power monitor PM. For this reason, it is preferable to use an antireflection film AC that permits high transmissivity Ts.

From the viewpoints of the incidence-angle dependence, optical layout, and other factors described above, it is preferable that the main polarized component of the laser beam L1 incident on the polarizing beam splitter BS be s-polarized and fulfill condition (1) below. Fulfilling condition (1) makes it possible to make the most of the polarizing beam splitting characteristics of the polarizing beam splitting film PC to achieve better optical path splitting.
35≦θ1≦65 (1)
where
θ1 represents the angle of incidence (°) at which the principal ray of the laser beam is incident on the polarizing beam splitter.

The laser beam L1 having been reflected from the polarizing beam splitter BS is then incident on a collimator optical system CL. The collimator optical system CL converts the laser beam L1 that has entered it into a substantially parallel beam. The collimator optical system CL has a two-unit, two-element construction wherein a convex lens and a concave lens are arranged with an air gap secured therebetween. This air gap can be varied by an actuator (not illustrated). By varying the air gap, it is possible to vary the angle of divergence of the laser beam L1 that exits from the collimator optical system CL and thereby adjust the wavefront aberration produced by the error in the substrate thickness of the optical disk DK. The laser beam L1 having been converted into a substantially parallel beam by the collimator optical system CL is then converted into circular-polarized light by a quarter-wave plate QW, then passes through the aperture stop AP, and is then, by an objective lens OL, focused, as a light spot with predetermined numerical apertures NA (for example, NA=0.65, 0.85), on the information recording surface SK of the optical disk DK. The objective lens OL may be, instead of a single-lens type, a twin-lens type.

The laser beam L1 focused on the information recording surface SK is then reflected therefrom to become return light, then passes through the objective lens OL, aperture stop AP, quarter-wave plate QW, and collimator optical system CL in this order to return to the polarizing beam splitter BS. While returning to the polarizing beam splitter BS, the laser beam L1 passes through the quarter-wave plate QW, and thus it is incident as p-polarized light on the polarizing beam splitting film PC. When the angle of incidence θ1 of the laser beam L1 relative to the polarizing beam splitting film PC is 45° and the range of angles α1 thereof (the angular aperture thereof) is 5°, the polarizing beam splitting film PC offers p-polarized light transmissivity Tp of 90% or more. Thus, the polarizing beam splitter BS can transmit the return light from the optical disk DK with high efficiency. This transmission of the p-polarized component forms the optical path from the optical disk DK to the photodetector PD. Thus, the laser beam L1 having been transmitted through the polarizing beam splitter BS is, through a sensor lens SL, condensed on an photodetector PD that belongs to a signal system.

In this embodiment, focusing errors are detected by the astigmatism method, and tracking errors are detected by the PP(push-pull) method or DPP (differential push-pull) method. As described earlier, when the laser beam L1 passes through the inclined parallel-plane plate PT, astigmatism is produced therein. This makes it possible to obtain a focus error signal in a simple construction. The photodetector PD is built as multiply divided PIN photodiodes of which each yields a current output, or an I-V converted voltage output, that is proportional to the intensity of the light beam incident thereon. The output of the photodetector PD is fed to a detection circuit system (not illustrated) to produce an information signal, a focus error signal, and a track error signal. Based on these focus error and track error signals, a secondary actuator (not illustrated) including a magnetic circuit, a coil, and other components controls the position of the objective lens OL, which is provided integrally therewith, in such a way that the light spot is always kept on an information track.

### Second Embodiment (Three-Wavelength Compatible Type)

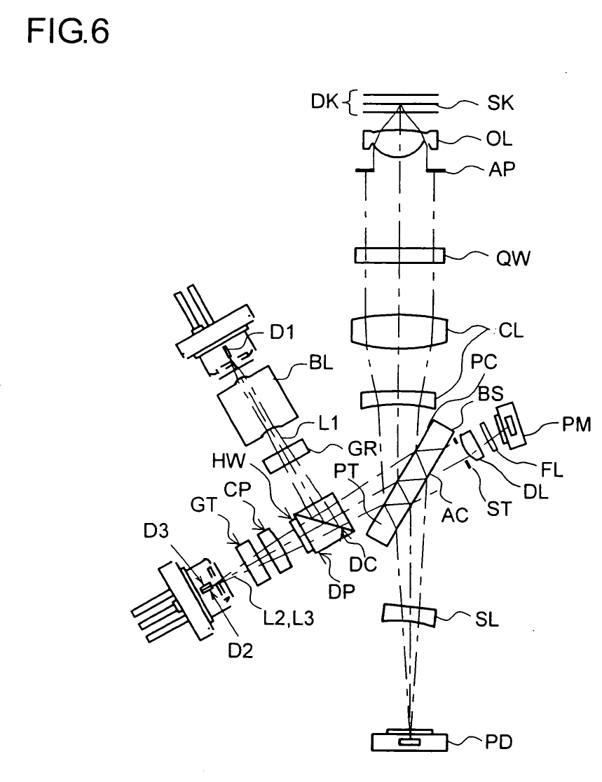

FIG. 6 shows the optical construction of the optical pickup apparatus of a second embodiment of the invention. This optical pickup apparatus is of a three-wavelength type that can record and reproduce optical information to and from any of a high-density medium adapted to a blue-violet laser, an optical information recording medium adapted to a red laser, and an optical information recording medium adapted to an infrared laser. The optical pickup apparatus includes, as semiconductor laser light sources, a blue laser light source D1 that emits a laser beam L1 in a 405 nm wavelength band (specifically, at a wavelength of 405±10 nm), a red laser light source D2 that emits a laser beam L2 in a 650 nm wavelength band (specifically, at a wavelength of 650±20 nm), and an infrared laser light source D3 that emits a laser beam L3 in a 780 nm wavelength band (specifically, at a wavelength of 780±20 nm). Here, only one of the three laser light sources D1 to D3 is lit at a time. Which of the laser light sources D1 to D3 to use is determined based on, for example, differences in thickness among different types of optical disk DK or certain information written on their information recording surfaces SK. The optical pickup apparatus is provided with a means (not illustrated) for making such judgments so that, according to a judgment so made, one of the three laser light sources D1 to D3 is lit. Thus, one of the laser beams L1 to L3 is emitted to achieve recording or reproduction of optical information to and from the information recording surface SK.

Of the three laser light sources D1 to D3, the red D2 and the infrared D3 are disposed close together and are housed in a common package; even then, these are arranged 110 μm away from each other, and therefore the laser beams emitted therefrom are focused at different positions. Optical information recording media (corresponding to the optical disk DK in the figure) adapted to different wavelengths have different depths to their information recording surfaces SK. This is dealt with by the objective lens OL described later, which so operates that, according to the type of optical disk DK with which recording or reproduction is actually performed, the laser beam L1, L2, or L3 is focused on the information recording surface SK.

The laser beam L1 emitted from the blue laser light source D1 is a divergent light beam having an elliptic light intensity distribution, of which the angle of divergence in the direction of the minor axis of the ellipse is equal to the angle of divergence θₚₐᵣ in the direction parallel to the active layer of the diode D1, and of which the angle of divergence in the direction of the major axis of the ellipse is equal to the angle of divergence θₚₑᵣₚ in the direction perpendicular to the active layer of the diode D1 (θₚₐᵣ<θₚₑᵣₚ). Specifically, in this embodiment, θₚₐᵣ=9° and θₚₑᵣₚ=23° (both given in full-angle at half maximum). In the arrangement of the blue laser light source D1 shown in FIG. 6, the angle of divergence θₚₑᵣₚ is parallel to the face of the page, and the angle of divergence θₚₐᵣ is perpendicular to the face of the page. Moreover, the laser beam L1 is linearly polarized in such a way that the electric vector thereof points in the direction parallel to the active layer of the blue laser light source D1.

The laser beam L2 or L3 emitted from the red or infrared laser light sources D2 or D3 is a divergent light beam having an elliptic light intensity distribution, of which the angle of divergence in the direction of the minor axis of the ellipse is equal to the angle of divergence θₚₐᵣ in the direction parallel to the active layer of the diode D2 or D3, and of which the angle of divergence in the direction of the major axis of the ellipse is equal to the angle of divergence θₚₑᵣₚ in the direction perpendicular to the active layer of the diode D2 or D3 (θₚₐᵣ<θₚₑᵣₚ). Specifically, in this embodiment, θₚₐᵣ=9° and θₚₑᵣₚ=16° (both given in full-angle at half maximum). In the arrangement of the red and infrared laser light sources D2 and D3 shown in FIG. 6, the angle of divergence θₚₐᵣ is parallel to the face of the page, and the angle of divergence θₚₑᵣₚ is perpendicular to the face of the page. Moreover, the laser beam L2 or L3 is linearly polarized in such a way that the electric vector thereof points in the direction parallel to the active layer of the red and infrared laser light source D2 or D3.

The laser beam L1 emitted from the blue laser light source D1 in the form of a divergent light beam with an elliptic light intensity distribution is then shaped, by a beam shaping element BL, into a light beam having a light intensity distribution that offers preferable characteristics for the recording and reproduction of optical information. Here, a preferable light intensity distribution is one that gives the light beam, when it is incident on the objective lens OL described later, peripheral intensity ratios (rim intensity) of, for example, 65% in the disk-radial direction and 60% in the disk-tangential direction. The angle of divergence θₚₑᵣₚ of 23° can be allocated to the rim intensity of 65% in the disk-radial direction by directing part of the laser beam L1 corresponding to an NA (numerical aperture) of 0.155 to the aperture stop AP of the objective lens OL; the angle of divergence θₚₐᵣ of 9° can be allocated to the rim intensity of 60% in the disk-tangential direction by directing part of the laser beam L1 corresponding to an NA (numerical aperture) of 0.067 to the aperture stop AP of the objective lens OL. In this embodiment, to obtain the desired rim intensity mentioned above, the beam shaping element BL is given a shaping magnification factor of 0.43× in the direction of the angle of divergence θₚₑᵣₚ and a unity magnification factor in the direction of the angle of divergence θₚₐᵣ.

The laser beam L1 having been shaped by the beam shaping element BL is then incident on a diffraction grating GR, which, for the purpose of tracking by the DPP method or three-beam method, splits the laser beam into a main beam (light of order 0) used to achieve recording and reproduction to and from the optical disk DK and two sub beams (light of orders ±1, omitted in FIG. 6) used to detect tracking errors. The laser beam (main beam) L1 that has exited from the diffraction grating GR is then incident on an optical path integrating prism DP.

On the other hand, the laser beam L2 or L3 emitted from the red or infrared laser light source D2 or D3 in the form of divergent light beam with an elliptic light intensity distribution is then incident on a diffraction grating GT, which, for the purpose of tracking by the DPP method or three-beam method, splits the laser beam into a main beam (light of order 0) used to achieve recording and reproduction to and from the optical disk DK and two sub beams (light of orders ±1, omitted in FIG. 6) used to detect tracking errors. The laser beam (main beam) L2 or L3 that has exited from the diffraction grating GR is then incident on a coupling lens CP. By way of this route, the laser beam L2 or L3 is, with its elliptic light intensity distribution intact, made incident on the objective lens θL. Accordingly, to strike a proper balance between the emission efficiency and the rim intensity, the angles of divergence of the laser beam L2 or L3 is converted by the coupling lens CP. The laser beam L2 or L3 having its angle of divergence converted by the coupling lens CP then has its polarization direction turned by 90° by a half-wave plate HW, and is then incident on the optical path integrating prism DP.

In this construction, no beam shaping is performed on the laser beam L2 or L3. This makes it necessary to align the θₚₑᵣₚ mainly in the disk-tangential direction. By contrast, the alignment of the blue laser light source D1 can be varied by varying how beam shaping is performed on the laser beam L1. Accordingly, the half-wave plate HW may be disposed not in the optical path of the laser beam L2 or L3 but in that of the laser beam L1. In this way, the half-wave plate HW may be disposed as actually desired. This helps change the arrangement of the individual optical elements relative to one another with a view to making the optical pickup apparatus as a whole slimmer or otherwise improved.

The optical path integrating prism DP has two glass prisms bonded together with a dichroic film DC, which is a multilayer optical thin film, interposed therebetween. The dichroic film DC has wavelength selectivity such that it reflects the laser beam L1 in the 405 nm wavelength band and transmits the laser beams L2 and L3 in the 650 nm and 780 nm wavelength bands. Accordingly, the three laser beams L1 to L3 have their optical paths integrated together by the optical path integrating prism DP so as to incident on the polarizing beam splitter BS along a common path.

The dichroic film DC provided in the optical path integrating prism DP may be one that has wavelength selectivity such that it transmits the laser beam L1 in the 405 nm wavelength band and reflects the laser beams L2 and L3 in the 650 nm and 780 nm wavelength bands. In this case, the optical path of the blue laser light source D1 and the optical paths of the red and infrared laser light sources D2 and D3 are interchanged. To reduce return light, it is also possible to use an optical path integrating prism DP that has polarizing beam splitting characteristics with respect to the laser beams L2 and L3; the half-wave plate HW may be omitted as necessary.

When the laser beam L1, L2, or L3 is incident on the polarizing beam splitter BS in the shape of a parallel-plane plate, its angle of incidence θ1 relative to the polarizing beam splitting film PC is 60°, and its range of angles (angular aperture) α1 is 4°. The polarizing beam splitter BS is composed of a transparent parallel-plane plate PT that serves as a substrate, a polarizing beam splitting film PC that is a multilayer optical thin film (or a multilayer optical thin film coated with a protective film) laid on one side of the parallel-plane plate PT, and an antireflection film AC that is a multilayer optical thin film (or a multilayer optical thin film coated with a protective film) laid on the other side of the parallel-plane plate PT. The polarizing beam splitting film PC has such polarizing beam splitting characteristics as to reflect most of the s-polarized component of the incident light beam and transmit most of the p-polarized component thereof. The laser beam L1, L2, or L3 is s-polarized with respect to the polarizing beam splitting film PC. Accordingly, the laser beam L1, L2, or L3 is mostly reflected from the polarizing beam splitting film PC, which is kept in contact with air. This forms the optical paths from the laser light sources D1 to D3 to the optical disk DK.

By making the beam L1, L2, or L3 incident on the polarizing beam splitter BS at an angle of incidence θ1 of 60° relative to the polarizing beam splitting film PC thereof, it is possible to obtain enhanced polarizing beam splitting performance, and to realize, without making the parallel-plane plate PT unduly thick, a detection system that produces large astigmatism but relatively small coma. Permitting the angle of incidence θ1 to be set at other than 45° offers the advantage of increasing flexibility in the design of the optical pickup apparatus.

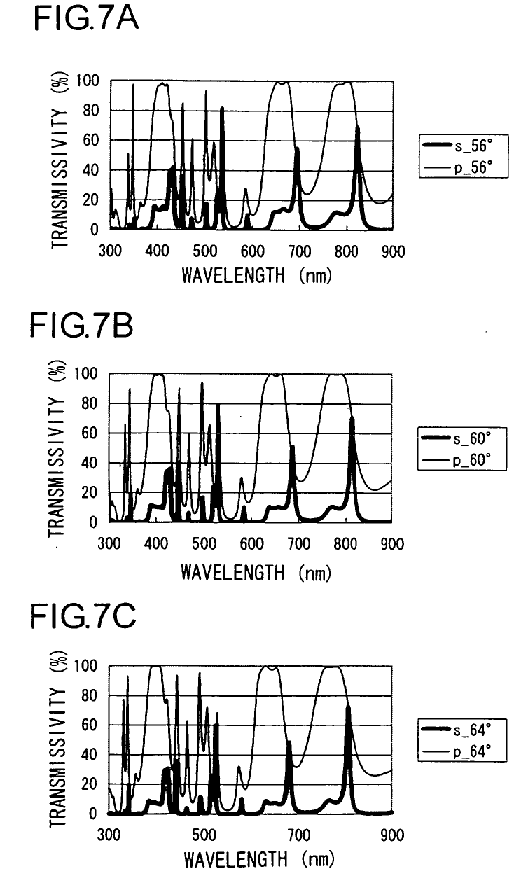

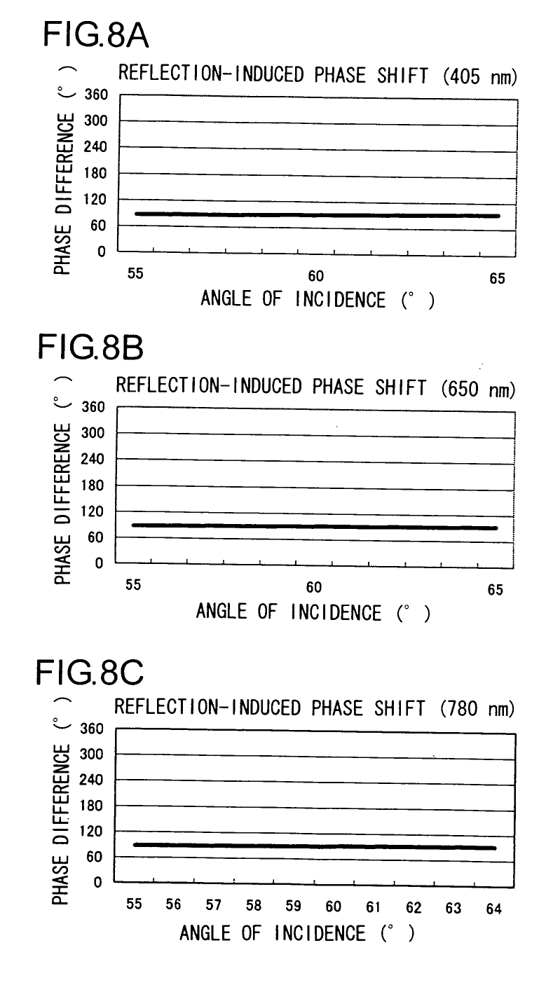

FIGS. 7A to 7C show, in terms of transmissivity (%), the polarizing beam splitting characteristics of the polarizing beam splitting film PC used at angles of incidence of 60±4° (more specifically, 56°, 60°, and 64° in FIGS. 7A, 7B, and 7C, respectively) relative to the film surface in three wavelength bands (the 405 nm, 650 nm, and 780 nm wavelength bands), with thick lines representing s-polarized light transmissivity and thin lines p-polarized light transmissivity. Having such polarizing beam splitting characteristics, this polarizing beam splitting film PC is optimized for use in the second embodiment. Its characteristics are good, offering p-polarized light transmissivity Tp>92% and s-polarized light reflectivity Rs>95% in the actual use range of wavelengths from 400 nm to 415 nm in the range of angles of incidence of 60±4°; p-polarized light transmissivity Tp>90% and s-polarized light reflectivity Rs>95% in the actual use range of wavelengths from 650 nm to 665 nm and in the range of angles of incidence of 60±4°; and p-polarized light transmissivity Tp>90% and s-polarized light reflectivity Rs>95% in the actual use range of wavelengths from 780 nm to 795 nm and in the range of angles of incidence of 60±3°. FIGS. 8A to 8C show the reflection-induced phase shift (the phase shift of s-polarized light observed at wavelengths of 405 nm, 650 nm, and 780 nm, respectively). As will be understood from FIGS. 8A to 8C, the reflection-induced phase shift is largely linear over the use angle range in all the wavelength bands.

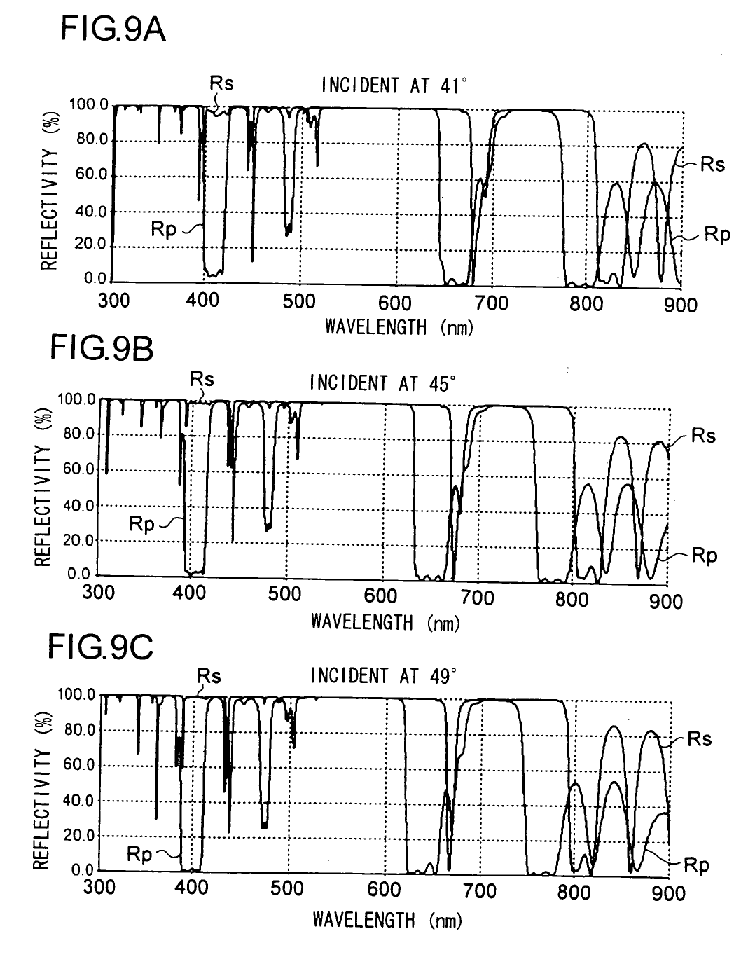

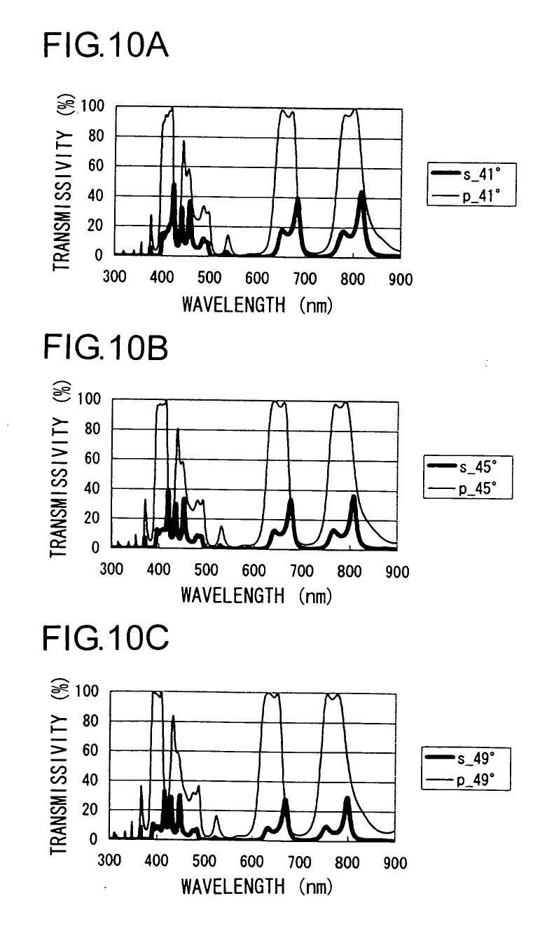

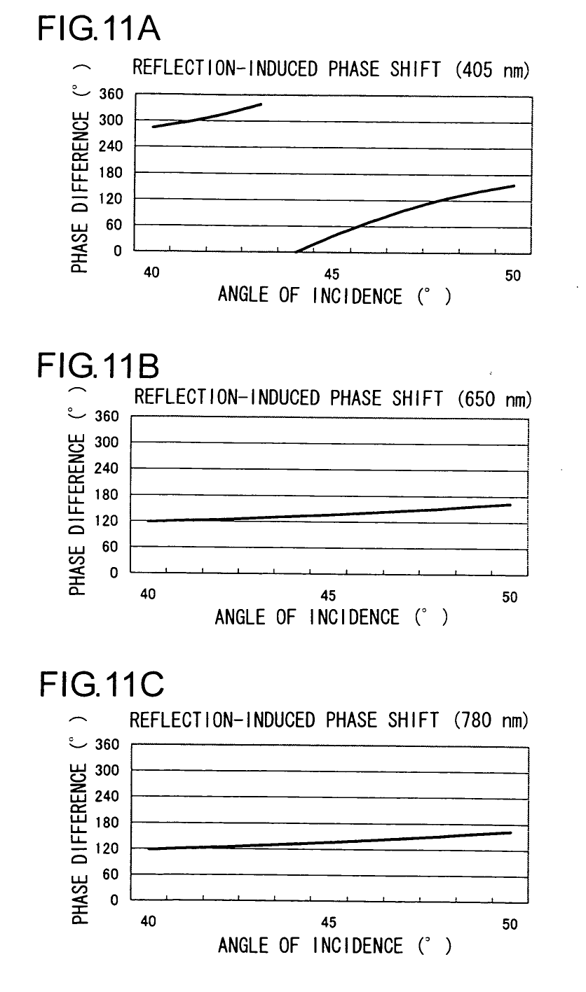

FIGS. 9A to 9C show, in terms of reflectivity (%), the polarizing beam splitting characteristics of the polarizing beam splitting film PC used at angles of incidence of 45±4° (more specifically, 41°, 45°, and 49° in FIGS. 9A, 9B, and 9C, respectively) relative to the film surface in three wavelength bands (the 405 nm, 650 nm, and 780 nm wavelength bands), with Rs representing s-polarized light reflectivity and Rp p-polarized light reflectivity. FIGS. 10A to 10C show, in terms of transmissivity (%), the polarizing beam splitting characteristics of the polarizing beam splitting film PC used at angles of incidence of 45±4° (more specifically, 41°, 45°, and 49° in FIGS. 10A, 10B, and 10C, respectively) relative to the film surface in three wavelength bands (the 405 nm, 650 nm, and 780 nm wavelength bands), with thick lines representing s-polarized light transmissivity and thin lines p-polarized light transmissivity. Having such polarizing beam splitting characteristics, this polarizing beam splitting film PC is optimized for a modified arrangement of the polarizing beam splitter BS as compared with its arrangement in the second embodiment. Its characteristics are good, offering p-polarized light transmissivity Tp>92% and s-polarized light reflectivity Rs>95% in the actual use range of wavelengths from 400 nm to 415 nm in the range of angles of incidence of 45±4°; p-polarized light transmissivity Tp>90% and s-polarized light reflectivity Rs>95% in the actual use range of wavelengths from 650 nm to 665 nm and in the range of angles of incidence of 45±4°; and p-polarized light transmissivity Tp>90% and s-polarized light reflectivity Rs>95% in the actual use range of wavelengths from 780 nm to 795 nm and in the range of angles of incidence of 45±3°. FIGS. 11A to 11C show the reflection-induced phase shift (the phase shift of s-polarized light observed at wavelengths of 405 nm, 650 nm, and 780 nm, respectively). As will be understood from FIGS. 11A to 11C, the reflection-induced phase shift is largely linear over the use angle range in all the wavelength bands.

As described earlier, the polarizing beam splitting film PC, which is a multilayer optical thin film, has such polarizing beam splitting characteristics as to reflect most of the s-polarized component of the incident light beam and transmit most of the p-polarized component thereof. To obtain better polarizing beam splitting characteristics, it is generally preferable to reduce the angle of incidence and, where a divergent light beam is involved, to narrow the range of angles of divergence thereof. Accordingly, in a common optical pickup apparatus, a polarizing beam splitting film is typically disposed on a bonding surface inside a glass cube so as to be located in the optical path of a divergent light beam. However, a polarizing beam splitter in the form of a glass cube has a complicated construction involving bonding surfaces, and requires many components; thus, using one leads not only to higher cost but also to less flexibility in the optical layout, resulting in a complicated optical construction. This makes it difficult to make the optical pickup apparatus, and hence the disk apparatus that incorporates it, lightweight, slim, compact, inexpensive, and otherwise improved.

In the construction of this embodiment, the laser beam L1, L2, or L3 after shaping is reflected from the polarizing beam splitting film PC, which is kept in contact with air. This helps simplify the optical construction needed for optical path splitting, and helps increase flexibility in the optical layout. This makes it easy to make the optical pickup apparatus lightweight, slim, compact, and inexpensive. Moreover, the use of the polarizing beam splitter BS in the shape of a parallel-plane plate makes it possible to produce astigmatism in the return light that is transmitted therethrough. This makes it possible to achieve focusing and error detection by the astigmatism method. This helps simplify the manufacturing process of the polarizing beam splitter BS, and eliminates the need for an extra element for producing astigmatism, thereby contributing to cost reduction in the optical pickup apparatus. Moreover, since no bonding surfaces are necessary, no absorption of light occurs as would be inevitable through an adhesive layer. This makes it possible to realize an optical system with high light use efficiency. In this way, it is possible to realize an optical pickup apparatus that can cope with high-density media adapted to a blue-violet laser and that can be made compact and inexpensive easily despite having a simple construction.

As described above, to obtain better polarizing beam splitting characteristics, it is preferable to narrow the range of angles of divergence. It is to fulfill the incidence-angle dependence thereof that the beam shaping element BL is used in this embodiment. Specifically, the beam shaping element BL, which reduces the angle of divergence θₚₑᵣₚ, is disposed where the laser beam L1 travels before being incident on the polarizing beam splitter BS. Thus, the beam shaping element BL reduces the angle of divergence of the laser beam L1 in the direction of the ellipse major axis so that the range of angles of incidence thereof relative to the polarizing beam splitting film PC is, although it is incident thereon in air, narrowed to 60±4°. This make it possible to achieve optical path splitting with polarizing beam splitting characteristics that best suit the incidence-angle dependency of the polarizing beam splitter. Moreover, from the viewpoint of film design, narrowing the range of angles of incidence with the beam shaping element BL makes it easy to make the reflection phase of s-polarized light linear. Also in this embodiment, from the viewpoints of the incidence-angle dependence, optical layout, and other factors described above, it is preferable that the main polarized component of the laser beam L1, L2, or L3 incident on the polarizing beam splitter BS be s-polarized and fulfill condition (1) noted earlier. Fulfilling condition (1) makes it possible to make the most of the polarizing beam splitting characteristics of the polarizing beam splitting film PC to achieve better optical path splitting.

The polarizing beam splitter BS is so designed as to transmit part of the s-polarized component of the laser beam L1, L2, or L3 incident thereon. The laser beam L1, L2, or L3 that has been transmitted through the polarizing beam splitter BS pass through a stop ST, then through a condenser lens DL, and then through an optical filter FL, and is then received by a laser power monitor PM. The laser power monitor PM is a monitoring sensor that detects the laser output intensity of the individual laser light sources D1 to D3 by receiving the laser beam L1, L2, or L3 that has been transmitted through the polarizing beam splitter BS. As in the first embodiment (FIG. 12), this laser power monitor PM is arranged with a slight upward inclination. This arrangement makes the incidence of the principal ray PX relative to the photodetective surface of the laser power monitor PM nonperpendicular, and thus helps avoid stray light and thereby prevent ghosts.

As described earlier, ideally, the output of the laser power monitor PM for APC should be proportional to the laser output and not depend on wavelength. In reality, however, the sensitivity of a photodetector commonly used as the laser power monitor PM is highly dependent on wavelength, and its sensitivity decreases with decreasing wavelength, with the peak in a 780 nm wavelength band. FIG. 14 shows the spectroscopic sensitivity characteristics of two types of photodetector identified as M405 and M655, respectively. Both exhibit high wavelength dependence in the 405 nm wavelength band, and output, even at the same laser power, increasingly high laser output with increasing wavelength. In a common semiconductor laser light source, wavelength variation (±17 nm) is inevitable that results from a variation in temperature, in the laser output level, or in any other relevant factor. Thus, when the laser wavelength shifts to longer wavelengths as a result of a variation in temperature or the like, even if there is no variation in the laser output, the monitor output increases.

On the other hand, in the polarizing beam splitting characteristics (FIGS. 7A-7C, 9A-9C, and 10A-10C) of the polarizing beam splitting film PC, entrance-angle dependence is recognized in the variation of s-polarized light reflectivity Rs and transmissivity Ts in the 405 nm wavelength band. When attention focused on the s-polarized light that is incident on the laser power monitor PM, for example as will be understood from the spectroscopic reflectivity shown in FIGS. 7A to 7C, as the angle of incidence increases, s-polarized light transmissivity Ts (thick lines) decreases at longer wavelengths in the 405 nm wavelength band. As described earlier, in a common semiconductor laser light source, wavelength variation (+17 nm) is inevitable that results from a variation in temperature, in the laser output level, or in any other relevant factor. Thus, when the laser wavelength shifts to longer wavelengths as a result of a variation in temperature or the like, the larger the angle of incidence, the more the amount of light incident on the laser power monitor PM decreases.

Accordingly, with the construction in which the laser power monitor PM receives the laser beam L1, L2, or L3 in a position where the center line QX of the effective light beam does not coincide with the principal ray PX of the laser beam L1, L2, or L3 that has been transmitted through the polarizing beam splitter BS, it is possible to match the spectroscopic sensitivity characteristics of the laser power monitor PM with the polarizing beam splitting characteristics of the polarizing beam splitting film PC. The photodetective range of the laser power monitor PM is effectively restricted by the stop ST.

In this embodiment, the center line QX of the effective light beam for the laser power monitor PM is located in the region traveled by the rays that have been transmitted through the polarizing beam splitting film PC at larger angles of incidence than the principal ray PX of the laser beam L1, L2, or L3 incident on the polarizing beam splitter BS. Accordingly, when the laser wavelength shifts to longer wavelengths, the photodetective sensitivity of the laser power monitor PM increases, and the amount of light incident thereon decreases. By contrast, when the laser wavelength shifts to shorter wavelengths, the photodetective sensitivity of the laser power monitor PM decreases, and the amount of light incident thereon increases. In this way, the spectroscopic sensitivity characteristics of the laser power monitor PM and the polarizing beam splitting characteristics of the polarizing beam splitting film PC complement each other so as to alleviate the influence of wavelength variation resulting from a variation in temperature, in the laser output level, or in any other relevant factor. Thus, it is possible to realize an optical pickup apparatus that can cope with high-density media adapted to a blue-violet laser and that can highly accurately control the amounts of light contained in the laser beams L1 to L3 despite having a simple construction.

The polarizing beam splitter BS receives as p-polarized light the return light from the optical disk DK, and therefore it offers, even without the antireflection film AC, sufficiently high transmissivity Tp. Accordingly, the antireflection film AC may be omitted. However, without the antireflection film AC, an unnegligible reflection loss occurs in the s-polarized light used by the laser power monitor PM. For this reason, it is preferable to use an antireflection film AC that permits high transmissivity Ts.

Between the polarizing beam splitter BS and the laser power monitor PM is disposed the optical filter FL that fulfills condition (2) below with respect to the laser beam L1, L2, or L3 that has been transmitted through the polarizing beam splitter BS. The use of the optical filter FL that fulfills condition (2) makes it possible to monitor the laser output intensity with the amount of light that suits the wavelength thereof.
TS655<TS405 (2)
where
TS405 represents the transmissivity (%) of the s-polarized component of the laser beam in the 405 nm wavelength band; and
TS655 represents the transmissivity (%) of the s-polarized component of the laser beam in the 655 nm wavelength band.

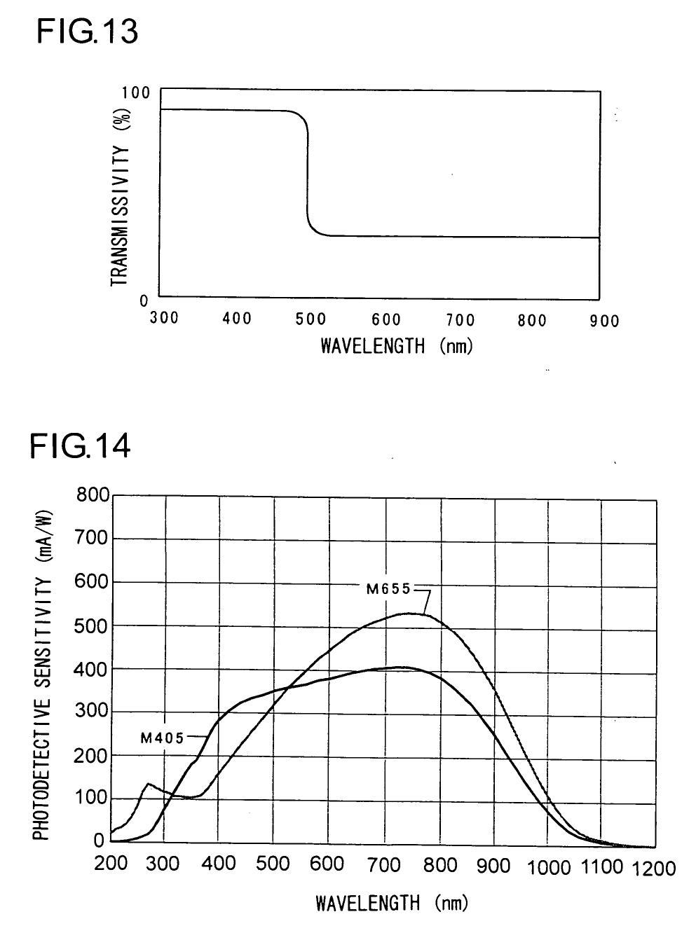

The optical filter FL that has wavelength selectivity as described above performs color balance adjustment on the laser beam L1, L2, or L3 that has been transmitted through the polarizing beam splitter BS. Then, by receiving the laser beam L1, L2, or L3 that has been transmitted through the optical filter FL, the laser power monitor PM detects the laser output intensity of the laser light sources D1 to D3. The laser output intensity of the laser light sources D1 to D3 differs from one another, and in addition the sensitivity ratio of the photodetector used as the laser power monitor PM varies from one wavelength to another (for example, 300 mA/W:400 mA/W). Accordingly, in a case where three wavelengths are handled with a single laser power monitor PM, the detection output, which depends on the amount of light received and the photodetective sensitivity, needs to be so balanced as to be equal for the three different wavelengths. In general, a blue laser light source yields a lower laser output than red and infrared light sources. This makes it preferable to diminish (for example, by 30 to 60%) the amount of light contained in the red or infrared laser beam L2 or L3 by the use of the optical filter FL. For example, it is preferable to use an optical filter FL having a spectroscopic transmissivity characteristic as shown in FIG. 13. If the optical disk DK is irradiated with the amount of light higher than formulated in the standards (for example, 0.35 mW with high-density media and 0.70 to 1.00 mW with DVDs and CDs), the information recorded on the optical disk DK is at the risk of being erased. By contrast, irradiating it with an insufficient amount of light makes it difficult to read the information recoded thereon. Accordingly, it is preferable to use an optical filter FL that has a spectroscopic transmission characteristic that suits the amount of light formulated in the standards for the actually used optical disk DK.

In this embodiment, the optical filter FL is disposed between the condenser lens DL and the laser power monitor PM. The optical filter FL may be disposed anywhere else between the polarizing beam splitter BS and the laser power monitor PM. For example, the optical filter FL may be disposed on the laser power monitor PM, or may be realized with a filter film formed on the back side of the polarizing beam splitter BS. Forming a filter film on the back side of the parallel-plane plate PT constituting the polarizing beam splitter BS makes it possible to realize an optical filter FL at low cost without increasing the number of components. In this case, the optical path of the signal light and the optical path to the laser power monitor PM are more likely to overlap, and this may affect the monitor light. This overlap can be avoided by reducing the angle of incidence and increasing the thickness of the parallel-plane plate PT so that the optical paths are separated by refraction.

As described above, the red and infrared laser light sources D2 and D3 yield higher laser outputs than the blue laser light source D1. This permits the polarizing beam splitter BS to have comparatively low p-polarized light transmissivity with respect to the laser beams L2 and L3. Even then, it is preferable that the polarizing beam splitter BS have a flat incidence-angle characteristic or, even when not flat, one according to which p-polarized light transmissivity for both laser beams increases as the angle of incidence deviates. Since the red and infrared light sources D2 and D3 yield high laser outputs, it is also possible to use a polarizing beam splitter BS that achieves optical path splitting through a half-mirror function that performs, only on the laser beams L2 and L3, optical path splitting that does not depend on polarization.

The laser beam L1, L2, or L3 having been reflected from the polarizing beam splitter BS is then incident on a collimator optical system CL. The collimator optical system CL converts the laser beam L1, L2, or L3 that has entered it into a substantially parallel beam. The collimator optical system CL has a two-unit, two-element construction wherein a convex lens and a concave lens are arranged with an air gap secured therebetween. This air gap can be varied by an actuator (not illustrated). By varying the air gap, it is possible to vary the angle of divergence of the laser beam L1, L2, or L3 that exits from the collimator optical system CL and thereby adjust the wavefront aberration produced by the error in the substrate thickness of the optical disk DK. The laser beam L1, L2, or L3 having been converted into a substantially parallel beam by the collimator optical system CL is then converted into circular-polarized light by a quarter-wave plate QW, then passes through the aperture stop AP, and is then, by an objective lens OL of a multiple wavelength compatible type that offers good focusing performance at all the three wavelength mentioned above, focused, as a light spot, on the information recording surface SK of the optical disk DK. The objective lens OL may be, instead of a single-lens type, a twin-lens type.

Here, since convergent light beams suitable for different types of optical disk DK are produced by the use of a single objective lens OL, if the actual use numerical apertures NA of the laser beams L1, L2, and L3 are approximately 0.85, 0.65, and 0.50, respectively, the ranges of angels of incidence are ±4°, ±3.1°, and ±2.4°, respectively. Accordingly, the polarizing beam splitting film PC is so designed as to deal with the laser beams L1 to L3 of the respective wavelengths in those ranges of angles of incidence. A liquid crystal correction element may be disposed in front of the objective lens OL with a view to correcting spherical aberration and coma. Using a liquid crystal correction element makes it possible to adjust spherical aberration and the like as achieved in a construction where the air gap in the collimator optical system CL is mechanically varied.

The laser beam L1, L2, or L3 focused on the information recording surface SK is then reflected therefrom to become return light, then passes through the objective lens OL, aperture stop AP, quarter-wave plate QW, and collimator optical system CL in this order to return to the polarizing beam splitter BS. While returning to the polarizing beam splitter BS, the laser beam L1, L2, or L3 passes through the quarter-wave plate QW, and thus it is incident as p-polarized light on the polarizing beam splitting film PC. When the angle of incidence 01 of the laser beam L1, L2, or L3 relative to the polarizing beam splitting film PC is 45° and the range of angles α1 thereof (the angular aperture thereof) is 5°, the polarizing beam splitting film PC offers p-polarized light transmissivity Tp of 90% or more. Thus, the polarizing beam splitter BS can transmit the return light from the optical disk DK with high efficiency. This transmission of the p-polarized component forms the optical path from the optical disk DK to the photodetector PD. Thus, the laser beam L1, L2, or L3 having been transmitted through the polarizing beam splitter BS is, through a sensor lens SL, condensed on an photodetector PD that belongs to a signal system.

In this embodiment, focusing errors are detected by the astigmatism method, and tracking errors are detected by the PP(push-pull) method or DPP (differential push-pull) method. As described earlier, when the laser beam L1, L2, or L3 passes through the inclined parallel-plane plate PT, astigmatism is produced therein. This makes it possible to obtain a focus error signal in a simple construction. The photodetector PD is built as multiply divided PIN photodiodes of which each yields a current output, or an I-V converted voltage output, that is proportional to the intensity of the light beam incident thereon. The output of the photodetector PD is fed to a detection circuit system (not illustrated) to produce an information signal, a focus error signal, and a track error signal. Based on these focus error and track error signals, a secondary actuator (not illustrated) including a magnetic circuit, a coil, and other components controls the position of the objective lens OL, which is provided integrally therewith, in such a way that the light spot is always kept on an information track.

It is to be understood that the embodiments described above include the constructions (i) to (vi) described below, according to which it is possible to realize an optical pickup apparatus that can cope with high-density media adapted to a blue-violet laser and that can highly accurately control the amount of light contained in a laser beam despite having a simple construction.

(i) An optical pickup apparatus comprising: a semiconductor laser light source that emits a laser beam in a 405 nm wavelength band; a beam shaping element that receives the laser beam emitted from the semiconductor laser light source, then shapes the laser beam, received in the form of a divergent light beam having an elliptic light intensity distribution, into a light beam having a substantially circular light intensity distribution, and then outputs the thus shaped laser beam; a polarizing beam splitter that reflects the laser beam shaped by the beam shaping element with a polarizing beam splitting film kept in contact with air and that transmits part of the laser beam; an objective lens that focuses the laser beam reflected from the polarizing beam splitter on an optical information recording medium; and a monitoring sensor that receives the laser beam transmitted through the polarizing beam splitting film to monitor the laser output intensity of the semiconductor laser light source, wherein the center line of the effective light beam received by the monitoring sensor is located in the region traveled by the rays that have been transmitted through the polarizing beam splitting film at larger angles of incidence than the principal ray of the laser beam incident on the polarizing beam splitter.

(ii) An optical pickup apparatus comprising: a first semiconductor laser light source that emits a laser beam in a 405 nm wavelength band; a second semiconductor laser light source that emits a laser beam in a 650 nm wavelength band; a beam shaping element that receives the laser beam emitted from the first semiconductor laser light source, then shapes the laser beam, received in the form of a divergent light beam having an elliptic light intensity distribution, into a light beam having a substantially circular light intensity distribution, and then outputs the thus shaped laser beam; an optical path integrator that integrates together the optical path of the laser beam shaped by the beam shaping element and the optical path of the laser beam emitted from the second semiconductor laser light source with a multilayer optical thin film; a polarizing beam splitter that reflects the laser beam having the optical paths thereof integrated together by the optical path integrator with a polarizing beam splitting film kept in contact with air and that transmits part of the laser beam; an objective lens that focuses the laser beam reflected from the polarizing beam splitter on an optical information recording medium; and a monitoring sensor that receives the laser beam transmitted through the polarizing beam splitting film to monitor the laser output intensity of the first and second semiconductor laser light sources, wherein the center line of the effective light beam received by the monitoring sensor is located in the region traveled by the rays that have been transmitted through the polarizing beam splitting film at larger angles of incidence than the principal ray of the laser beam incident on the polarizing beam splitter.

(iii) An optical pickup apparatus comprising: a first semiconductor laser light source that emits a laser beam in a 405 nm wavelength band; a second semiconductor laser light source that emits a laser beam in a 650 nm wavelength band; a third semiconductor laser light source that emits a laser beam in a 780 nm wavelength band and that is disposed close to the second semiconductor laser light source; a beam shaping element that receives the laser beam emitted from the first semiconductor laser light source, then shapes the laser beam, received in the form of a divergent light beam having an elliptic light intensity distribution, into a light beam having a substantially circular light intensity distribution, and then outputs the thus shaped laser beam; an optical path integrator that integrates together the optical path of the laser beam shaped by the beam shaping element and the optical paths of the laser beams emitted from the second and third semiconductor laser light sources with a multilayer optical thin film; a polarizing beam splitter that reflects the laser beam having the optical paths integrated together by the optical path integrator with a polarizing beam splitting film kept in contact with air and that transmits part of the laser beam; an objective lens that focuses the laser beam reflected from the polarizing beam splitter on an optical information recording medium; and a monitoring sensor that receives the laser beam transmitted through the polarizing beam splitting film to monitor the laser output intensity of the first, second, and third semiconductor laser light sources, wherein the center line of the effective light beam received by the monitoring sensor is located in the region traveled by the rays that have been transmitted through the polarizing beam splitting film at larger angles of incidence than the principal ray of the laser beam incident on the polarizing beam splitter.

(iv) An optical pickup apparatus as described in one of (i) to (iii) above, wherein the beam shaping element shapes the laser beam in such a way as to reduce the angle of divergence thereof in the direction of the major axis of the elliptic light intensity distribution thereof.

(v) An optical pickup apparatus as described in one of (i) to (iv) above, wherein the main polarized component of the laser beam incident on the polarizing beam splitter from the semiconductor laser light source side thereof is s-polarized and fulfills condition (1) noted earlier.

(vi) An optical pickup apparatus as described in one of (ii) to (v) above, wherein the polarizing beam splitter transmits part of the s-polarized component of the laser beam and includes an optical filter that fulfills condition (2) described earlier with respect to the transmitted laser beam, and the monitoring sensor receives the laser beam transmitted through the optical filter to monitor the laser output intensity of the semiconductor laser light sources.

1. An optical pickup apparatus that detects optical information by making a laser beam in a 405 nm wavelength band emitted from a semiconductor laser light source incident on an optical information recording medium and then making the laser beam reflected from the optical information recording medium incident on a photodetector, the optical pickup apparatus comprising:
a polarizing beam splitter including a polarizing beam splitting film that forms an optical path from the semiconductor laser light source to the optical information recording medium by reflecting an s-polarized component of the laser beam and that forms an optical path from the optical information recording medium to the photodetector by transmitting a p-polarized component of the laser beam; and
a monitoring sensor that receives the laser beam to monitor laser output intensity of the semiconductor laser light source,
wherein the polarizing beam splitter transmits part of the s-polarized component, and the monitoring sensor receives this part of the s-polarized component in a position where a center line of an effective light beam received by the monitoring sensor does not coincide with a principal ray of that part of the s-polarized component.

2. An optical pickup apparatus as claimed in claim 1,
wherein the laser beam incident on the polarizing beam splitter is a divergent light beam, and the center line of the effective light beam received by the monitoring sensor is located in a region traveled by rays that have been transmitted through the polarizing beam splitting film at larger angles of incidence than a principal ray of the divergent light beam.

3. An optical pickup apparatus comprising:
a semiconductor laser light source that emits a laser beam in a 405 nm wavelength band;
a beam shaping element that receives the laser beam emitted from the semiconductor laser light source, then shapes the laser beam, received in a form of a divergent light beam having an elliptic light intensity distribution, into a light beam having a substantially circular light intensity distribution, and then outputs the thus shaped laser beam;
a polarizing beam splitter that reflects the laser beam shaped by the beam shaping element with a polarizing beam splitting film kept in contact with air and that transmits part of the laser beam;
an objective lens that focuses the laser beam reflected from the polarizing beam splitter on an optical information recording medium; and
a monitoring sensor that receives the laser beam transmitted through the polarizing beam splitting film to monitor laser output intensity of the semiconductor laser light source, wherein a center line of an effective light beam received by the monitoring sensor is located in a region traveled by rays that have been transmitted through the polarizing beam splitting film at larger angles of incidence than a principal ray of the laser beam incident on the polarizing beam splitter.

4. An optical pickup apparatus comprising:
a first semiconductor laser light source that emits a laser beam in a 405 nm wavelength band;
a second semiconductor laser light source that emits a laser beam in a 650 nm wavelength band;
a beam shaping element that receives the laser beam emitted from the first semiconductor laser light source, then shapes the laser beam, received in a form of a divergent light beam having an elliptic light intensity distribution, into a light beam having a substantially circular light intensity distribution, and then outputs the thus shaped laser beam;
an optical path integrator that integrates together an optical path of the laser beam shaped by the beam shaping element and an optical path of the laser beam emitted from the second semiconductor laser light source with a multilayer optical thin film;
a polarizing beam splitter that reflects the laser beam having the optical paths thereof integrated together by the optical path integrator with a polarizing beam splitting film kept in contact with air and that transmits part of the laser beam;
an objective lens that focuses the laser beam reflected from the polarizing beam splitter on an optical information recording medium; and
a monitoring sensor that receives the laser beam transmitted through the polarizing beam splitting film to monitor laser output intensity of the first and second semiconductor laser light sources,
wherein a center line of an effective light beam received by the monitoring sensor is located in a region traveled by rays that have been transmitted through the polarizing beam splitting film at larger angles of incidence than a principal ray of the laser beam incident on the polarizing beam splitter.

5. An optical pickup apparatus comprising:
a first semiconductor laser light source that emits a laser beam in a 405 nm wavelength band;
a second semiconductor laser light source that emits a laser beam in a 650 nm wavelength band;
a third semiconductor laser light source that emits a laser beam in a 780 nm wavelength band and that is disposed close to the second semiconductor laser light source;
a beam shaping element that receives the laser beam emitted from the first semiconductor laser light source, then shapes the laser beam, received in a form of a divergent light beam having an elliptic light intensity distribution, into a light beam having a substantially circular light intensity distribution, and then outputs the thus shaped laser beam;
an optical path integrator that integrates together an optical path of the laser beam shaped by the beam shaping element and optical paths of the laser beams emitted from the second and third semiconductor laser light sources with a multilayer optical thin film;
a polarizing beam splitter that reflects the laser beam having the optical paths thereof integrated together by the optical path integrator with a polarizing beam splitting film kept in contact with air and that transmits part of the laser beam;
an objective lens that focuses the laser beam reflected from the polarizing beam splitter on an optical information recording medium; and
a monitoring sensor that receives the laser beam transmitted through the polarizing beam splitting film to monitor laser output intensity of the first, second, and third semiconductor laser light sources,
wherein a center line of an effective light beam received by the monitoring sensor is located in a region traveled by rays that have been transmitted through the polarizing beam splitting film at larger angles of incidence than a principal ray of the laser beam incident on the polarizing beam splitter.

6. An optical pickup apparatus as claimed in claim 3,
wherein the beam shaping element reduces an angle of divergence of the laser beam in a direction of a major axis of the elliptic light intensity distribution thereof.

7. An optical pickup apparatus as claimed in claim 4,
wherein the beam shaping element reduces an angle of divergence of the laser beam in a direction of a major axis of the elliptic light intensity distribution thereof.

8. An optical pickup apparatus as claimed in claim 5,
wherein the beam shaping element reduces an angle of divergence of the laser beam in a direction of a major axis of the elliptic light intensity distribution thereof.

9. An optical pickup apparatus as claimed in claim 1,
wherein a main polarized component of the laser beam incident on the polarizing beam splitter from a semiconductor laser light source side thereof is s-polarized and fulfills condition (1) below:
35≦θ1≦65 (1)
where
θ1 represents an angle of incidence (°) at which a principal ray of the laser beam is incident on the polarizing beam splitter.

10. An optical pickup apparatus as claimed in claim 3,
wherein a main polarized component of the laser beam incident on the polarizing beam splitter from a semiconductor laser light source side thereof is s-polarized and fulfills condition (1) below:
35≦θ1≦65 (1)
where
θ1 represents an angle of incidence (°) at which the principal ray of the laser beam is incident on the polarizing beam splitter.

11. An optical pickup apparatus as claimed in claim 4,
wherein a main polarized component of the laser beam incident on the polarizing beam splitter from a semiconductor laser light source side thereof is s-polarized and fulfills condition (1) below:
35≦θ1≦65 (1)
where
θ1 represents an angle of incidence (°) at which the principal ray of the laser beam is incident on the polarizing beam splitter.

12. An optical pickup apparatus as claimed in claim 5,
wherein a main polarized component of the laser beam incident on the polarizing beam splitter from a semiconductor laser light source side thereof is s-polarized and fulfills condition (1) below:
35≦θ1≦65 (1)
where
θ1 represents an angle of incidence (°) at which the principal ray of the laser beam is incident on the polarizing beam splitter.

13. An optical pickup apparatus as claimed in claim 4,
wherein the polarizing beam splitter transmits part of the s-polarized component of the laser beam and includes an optical filter that fulfills condition (2) below with respect to the transmitted laser beam, and the monitoring sensor receives the laser beam transmitted through the optical filter to monitor the laser output intensity of the semiconductor laser light sources:
TS655<TS405 (2)
where
TS405 represents transmissivity (%) of the s-polarized component of the laser beam in the 405 nm wavelength band; and
TS655 represents transmissivity (%) of the s-polarized component of the laser beam in the 655 nm wavelength band.

14. An optical pickup apparatus as claimed in claim 5,
wherein the polarizing beam splitter transmits part of the s-polarized component of the laser beam and includes an optical filter that fulfills condition (2) below with respect to the transmitted laser beam, and the monitoring sensor receives the laser beam transmitted through the optical filter to monitor the laser output intensity of the semiconductor laser light sources:
TS655<TS405 (2)
where
TS405 represents transmissivity (%) of the s-polarized component of the laser beam in the 405 nm wavelength band; and
TS655 represents transmissivity (%) of the s-polarized component of the laser beam in the 655 nm wavelength band.
